(19) United States
(12) Patent Application Publication
(10) Pub. No.: US 2022/0036469 A1
(43) Pub. Date: Feb. 3, 2022

(54) BATCH PROCESSING FOR BULK QUOTES SERVICE

(71) Applicant: Hippo Analytics Inc. dba Hippo Insurance Services, Palo Alto, CA (US)

(72) Inventors: Hagay Hanan, Palo Alto, CA (US); Yoram Hod, Sunnyvale, CA (US); Eric Gerhardinger, San Mateo, CA (US)

(21) Appl. No.: 16/983,809

(22) Filed: Aug. 3, 2020

(51) Int. Cl. G06Q 40/08; G06Q 40/02; G06F 16/21; G06F 16/23

(52) U.S. Cl. CPC G06Q 40/08; G06F 16/2386; G06F 16/212; G06Q 40/025

(57) ABSTRACT

A bulk quote service system and process including multiple processor instances having different states representing different quote record processing stages for processing respective quote records as parallel quote processing tasks. The system receives a bulk quote file and splits the bulk quote file into individually processable quote records. Each processor instance processes the quote records in parallel by validating a quote record, retrieving data for the validated quote record from at least one external data vendor, generating a rating for the validated quote record using data in the validated quote record and data retrieved from the at least one external data vendor, generating a final quote for the validated quote record using the data in the validated quote record, data from the at least one external data vendor, and the rating for the validated quote record, and associating the final quote with the validated quote record.

### TECHNICAL FIELD

The subject matter disclosed herein generally relates to computerized systems and methods for providing computerized quotes (e.g., estimated costs) for services (e.g., insurance services) and, in particular, to a system and method for providing bulk quotes to multiple recipients using leads created on-demand.

### BACKGROUND

Companies use computer systems to generate quotes for the estimated costs for providing a particular set of services. For example, insurance companies use computerized quoting systems to provide quotes for proposed insurance coverages. When marketing such services to many potential customers, the quotes may be generating in bulk. Existing bulk quoting implementations go through the full process of preparing a quote for each service and, as a result, are not optimized for bulk quoting. A single bulk quote may need to collect data individually from a variety of different vendors and will require multiple database transactions. Since the bulk quotes and the corresponding services production system usually share the same database resources, running a bulk quote process also impacts the performance of the services production system. In existing bulk quoting applications, the bulk quoting process may also result in a massive number of lead records created in the production database. Those potential quotes pollute the production database and are mixed with the “real” leads in the system. Existing bulk quoting processes also have a number of issues that prevent them from scaling to more partners and customers. For example, a manual intervention is required to ingest, run, and transmit files and the time to run may be as much as one hour per 10 k records.

### Summary of the Embodiments

In view of the limitations of existing systems, it is desired to provide bulk quotes as a computerized service that intakes prospects and returns pre-quotes that can be used in outbound marketing campaigns, and the like. This bulk quotes computerized service may be configured to readily expand in scale as more partners are added.

The systems and methods described herein address the afore-mentioned and other needs in the art by decoupling the bulk quotes service from the production infrastructure. The resulting bulk quotes service may save the quotes in its own dedicated database. The partner output file will contain links to a quote routed on this service. Generally, the potential quotes become active if and when a potential customer clicks the quote URL link. The lead is copied to the production database when the link is clicked and a redirect to the just-created-on-demand lead is generated in a short total response time (e.g., ˜400 ms).

In example embodiments, a bulk quote service system and process are provided that include multiple processor instances (hardware and/or software) having different states representing different quote record processing stages for processing respective quote records as parallel quote processing tasks. The system receives a bulk quote file and splits the bulk quote file into individually processable quote records. Each processor instance processes the quote records in parallel by validating a quote record, retrieving data for the validated quote record from at least one external data vendor, generating a rating (e.g., insurance premium rating) for the validated quote record using data in the validated quote record and data retrieved from the at least one external data vendor, generating a final quote (e.g., insurance quote) for the validated quote record using the data in the validated quote record, data from the at least one external data vendor, and the rating for the validated quote record, and associating the final quote with the validated quote record. A database may store the final quote with the validated quote record for each quote record processed by each instance of the at least one processor. The at least one processor may further output a plurality of final quotes associated with prospects.

In the example embodiments, the different states of the processor instances include input validated, ready for rating, eligible for quote, has credit score, quote complete, and quote rejected. Each processor instance may process a quote record from state to state independent of the processing of the other quote records by other processor instances.

In the example embodiments, the bulk quote file may include a comma separated values file including message data including a file path, a partner ID, and bulk quotes global parameters. Each instance of the at least one processor may validate the quote record by performing format validation for data in the quote record and accessing a third party validation service to validate information for a prospect in the bulk quote file.

In the example embodiments, each instance of the at least one processor may generate a rating for the validated quote record by retrieving at least one of a credit score or an insurance score associated with a prospect and using the credit score and/or insurance score associated with the prospect to generate the final quote. Each instance of the at least one processor may generate the final quote for the validated quote record by regenerating the rating with the credit score and/or insurance score, the data in the validated quote record, and the data retrieved from the at least one external data vendor. To facilitate processing, the at least one processor may assign a job ID to each quote record and, while a final quote is being generated, the at least one processor may retrieve data using the job ID. When all quote records for the job ID are either completed or rejected, all quote records for the job ID may be combined into a single output bundle for output.

In the example embodiments, to prevent quote duplication, the at least one processor may further check to determine whether a valid quote exists for a prospect and mark a quote record for the prospect as invalid when the valid quote exists.

In the example embodiments, the at least one processor also may generate an error log when processing of a quote record fails. The error log may include a reason for failure of the processing of the quote record. For example, the error log may indicate that the quote record could not be processed due to an issue with an insurance provider or a data vendor. When the quote record could not be processed due to an issue with a data vendor, the data vendor and the nature of the issue with the data vendor may be documented.

In the example embodiments, the at least one processor may further maintain a log that shows a state of processing of each quote record. The log may include a job ID, a partner ID, a total number of quote records, a number of errors, a number of successes, and a number of quote records remaining to be processed.

Further aspects include a machine-readable storage device that stores computer-executable instructions that, when executed by at least one processor, implements a method of providing bulk quotes. The instructions, when executed, may implement a method comprising: receiving a bulk quote file; splitting the bulk quote file into individually processable quote records; and processing, using multiple processor instances having different states representing different quote record processing stages, respective quote records as parallel quote processing tasks. In example embodiments, the processing by each processor instance includes validating a quote record, retrieving data for a validated quote record from at least one external data vendor, generating a rating for the validated quote record using data in the validated quote record and data retrieved from the at least one external data vendor, generating a final quote for the validated quote record using the data in the validated quote record, data from the at least one external data vendor, and the rating for the validated quote record, and associating the final quote with the validated quote record.

As discussed herein, the logic, commands, or instructions that implement aspects of the methods described herein be provided in a computing system including any number of form factors for the computing system such as desktop or notebook personal computers, mobile devices such as tablets, netbooks, and smartphones, client terminals and server-hosted machine instances, and the like. Another embodiment discussed herein includes the incorporation of the techniques discussed herein into other forms, including into other forms of programmed logic, hardware configurations, or specialized components or modules, including an apparatus with respective means to perform the functions of such techniques. The respective algorithms used to implement the functions of such techniques may include a sequence of some or all of the electronic operations described herein, or other aspects depicted in the accompanying drawings and detailed description below. Such systems and computer-readable media including instructions for implementing the methods described herein also constitute example embodiments.

This summary section is provided to introduce aspects of the inventive subject matter in a simplified form, with further explanation of the inventive subject matter following in the text of the detailed description. This summary section is not intended to identify essential or required features of the claimed subject matter, and the particular combination and order of elements listed this summary section is not intended to provide limitation to the elements of the claimed subject matter. Rather, it will be understood that the following section provides summarized examples of some of the embodiments described in the Detailed Description below.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example and not limitation in the figures of the accompanying drawings of which:

FIG. 1 illustrates an example workflow of a bulk quote service in an example embodiment.

FIG. 2 illustrates an example embodiment of the bulk quote service of FIG. 1.

FIG. 3 illustrates a state diagram for the quote processor of the bulk quote service of FIG. 2 in an example embodiment.

FIG. 4 illustrates a flow chart of the operation of the bulk quote service of FIG. 2 in an example embodiment.

FIG. 5 illustrates parallelization of the bulk quote service of FIG. 2 in an example embodiment.

FIGS. 6A and 6B together illustrate sample input fields in a spreadsheet for a bulk quote insurance system in an example embodiment.

FIG. 7 illustrates sample output fields in a spreadsheet for a bulk quote insurance system in an example embodiment.

FIG. 8 is a block diagram illustrating components of a machine, according to some example embodiments, able to read instructions from a machine-readable storage device and to perform any one or more of the methodologies discussed herein.

### DETAILED DESCRIPTION

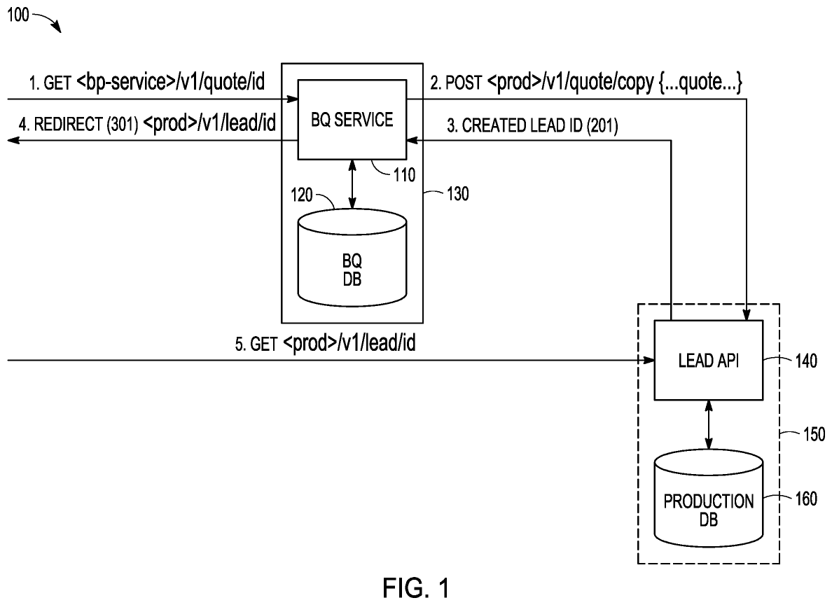

The following description with respect to FIGS. 1-8 sufficiently illustrates specific embodiments to enable those skilled in the art to practice them. Other embodiments may incorporate structural, logical, process, and other changes. Portions and features of some embodiments may be included in, or substituted for, those of other embodiments. Embodiments set forth in the claims encompass all available equivalents of those claims.

Example embodiments described herein will be described in connection with a bulk quote system for providing bulk quotes for services. It will be appreciated that the techniques described herein may be applied to bulk quote systems for providing bulk quotes for a number of different types of services where bulk quotes may be used, such as homeowners insurance, rental insurance, auto sales, or any service which requires logic in order to generate a quote.

### Terminology

Partner—An entity with a customer list to be quoted. In the use case of home insurance quotes, the partner may be a loan servicing entity.

Prospect—A customer or prospective customer of a partner. In the use case of home insurance quotes, the prospect may be a customer of a loan servicing entity where the customer is acquiring property to be evaluated for a home insurance quote.

Pre-quote—A quote generated for solicitation of a customer using promotional credit scores that do not require customer consent but require communication with a firm offer of services.

In the case of insurance services, loan servicers often partner with the insurance providers to provide insurance quotes for the property covered by the loan. The loan servicers have books of customers including their current home insurance premiums. It is desired on the part of the insurance company partner to provide insurance quotes to the loan servicer's customers based on the information available to the loan servicer and to send quotes and URLs that can be used to market to the loan servicers' customers with a pre-filled quote that can be readily accepted. Insurance companies may cooperate with partners with very large customer portfolios where it is desired to provide bulk quotes for insurance services in order to interact with the consumers in a number of ways including:

1) Direct e-mail campaign: An e-mail campaign provides the customer with a link that may be selected to obtain a quote from an insurance company partner. The link also may be co-branded and embedded within the partner's website whereby the customer is re-directed from the partners' webpage to the insurance company partner upon selection of the link.
2) The partner can display multiple options: The partner may display multiple insurance service options where the insurance company partner is one of the options. For example, lenders may provide multiple insurance service options. In this case, everything is prepared in the insurance company partner's system. On the other hand, in the case of an agent, for example, the agent would access the insurance company partner's system via a portal, retrieve the customer information, and call the customer directly. This process saves many steps because the customers are pre-quoted and the agent does not have to complete a new flow for each customer.
3) Community quotes: In the case of builders, for example, it may be desirable to quote communities in the builder's portfolio. In this case, the user would choose a community and then everything is pre-filled based on the community and the model information. Information is already pre-filled except for the name of the customer. The homeowner may call the builder or the builder's agency, and the builder or the builder's agency already has the models and the price as well as the price for the corresponding insurance product.

To implement these and other related capabilities, a system is described herein that creates a bulk quote by receiving a comma separated values (CSV) file with instructions for how to map a specific field and how to treat each column. A mapping in the file is created from the origin to a mapping within a system. Internal processing extracts address, personal information, coverages, estimate numbers, and details about property to be insured (e.g., roof age, roof type, condo, home, rented, owned, etc.). A dictionary of words and/or phrases for each column header may be used to match words or phrases in the column/header with a dictionary of words/phrases to make sure the columns/headers correspond. The fields may be analyzed to provide automatic mapping where appropriate. Conversely, manual mapping may be implemented with suggestions based on similarities. In example embodiments, the system may look at column headers and guess the attribute based on the name of the column header. The data within a column also may be analyzed in an effort to match the data with known streets, cities, and zip codes.

In alternative embodiments, all of the records may be loaded into an Amazon Simple Queue Service (SQS) message queue to enable a user to quote multiple addresses. The user may write the quote into a file and then write the file into an Amazon Simple Storage Service (S3) bucket.

FIG. 1 illustrates an example workflow of a bulk quoting service 100 in an example embodiment. As illustrated, the workflow starts by an entity requesting at (1) a quote (GET <bq-service>/v1/quote/id) from a bulk quoting (BQ) service 110 associated with a bulk quote database (BQ DB) 120 on a bulk quoting data microservice platform 130. The bulk quoting service 110 posts the requested quote (POST <prod>/v1/quote/copy{quote}) at (2) to the lead application programming interface (API) 140 of the production system 150, which further includes bulk quote production database 160. At (3), the lead API 140 provides a created lead id from the bulk quote production database 160 to the bulk quoting service 110, which redirects the lead id to the quote requesting entity (redirect <prod>/v1/lead/id) at (4). The redirected lead id is, in turn, redirected at (5) to the production lead in the lead API 140 (GET <prod>/v1/lead/id) for storage in the bulk quote production database 160.

Those skilled in the art will appreciated that since a rating-service creates the quote in the first place (although does not save it), the lead data may be copied and saved as is. The lead's data integrity may be assured by running live-migration and/or a one-off script on the bulk quote database 120. This may be done by a bulk-quote internal rating service.

Existing bulk quote implementations use the lead API 140 by mimicking the steps to create a quote. Since in the bulk quote flow all the input information is known upfront, the quoting flow may be rewritten to optimize for multiple quotes so that each step may be performed (e.g., input data validation, calls to data-vendors, quoting) only once. The ideal rating API needed for this quote flow may include only one interface which is a quote method. In example embodiments of the type described below, this quote method may be called by the bulk quote service 110 and will get the data-vendors reports as an input. It will be the responsibility of the bulk quote service 110 to cache and retrieve these reports. The bulk quote service 110 will return a lead that will be saved in the bulk quote database 120.

In example embodiments, the bulk quote API of FIG. 1 may be exposed to users via the following route:

```
POST /v1/bulk-quotes/quote
quote(
  validatedAddress, // Already validated address as returned from
  smartystreets
  personalInformation,
  propertyData,
  adjustments,
  product,
  VeriskReport
) {
  // validate the data (no additional data-vendors calls needed)
  // call the rater to get a quote
  // No need to persist anything in the database
  // Returns Lead object.
}
```

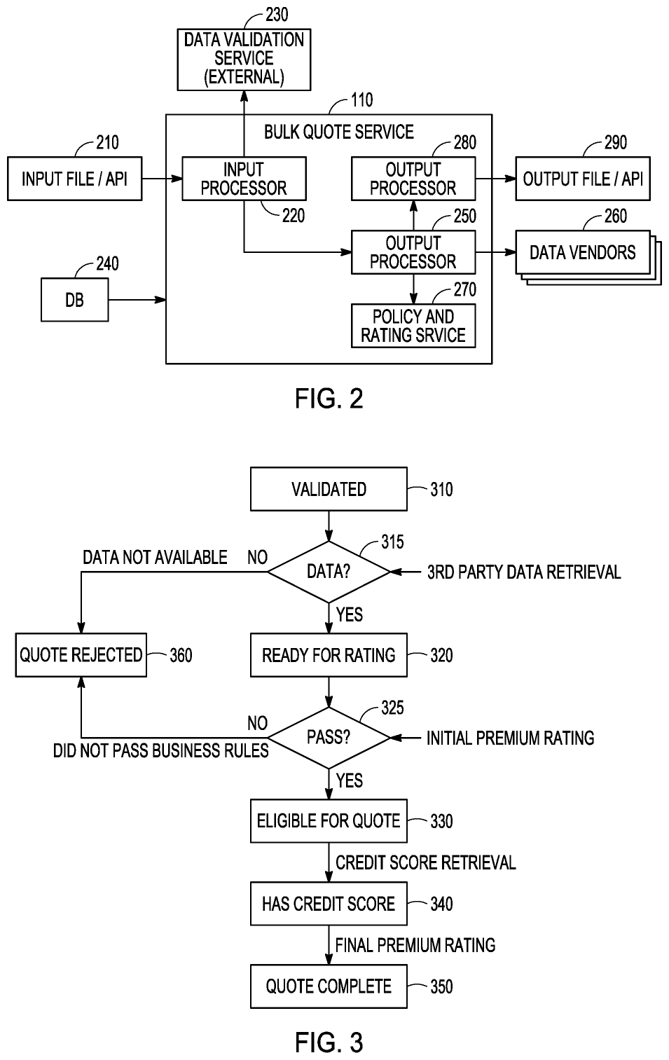

FIG. 2 illustrates an example embodiment of the bulk quote service 110 shown in FIG. 1. The bulk quote process may start with an input from an external partner, in the case of an example implementation, an Amazon Web Services S3 may be used as file storage for input files. However, it will be appreciated that the bulk quote process may be initiated using API calls, Secure File Transfer Protocol (SFTP) uploads, emails, and the like. In such an embodiment, a bulk quotes input file 210 (e.g., an S3 input file) may be uploaded to a memory (e.g., an S3 bucket) as a new bulk-quotes file. The bulk quotes file 210 may be added to a Simple Notification Service (SNS) topic, and the bulk quotes file 210 may include message data including a file path, a partner ID, bulk quotes global parameters, etc. The quote process may be triggered by a script that adds a message to a bulk quote new file queue (e.g., a Simple Queue Service (SQS) queue). For example, the script may be a simple hypertext transfer protocol (HTTP) payload template that calls a route on the SNS message service. The script may be run manually, get the file's path, the partner id, and the bulk quotes global parameters, and may add a message to a bulk quote new file (SQS) queue. The message added to the bulk quote new file queue may include the file's path, the partner id, and the bulk quotes global parameters.

Once an input has been received by the bulk quoting service 110, it is processed by an input processor 220. The input processor 220 splits the input into individually processable quote records and assigns a job ID to each quote record so that it is possible to group the quote records back together later on in the process. In addition, the input processor 220 validates every quote record to make sure that it is workable. Examples for validations include format validation (phone numbers, e-mail addresses, etc.) that may be performed by the input processor 220 and third party validations performed by a third party validation service 230 (e.g., residential street address validation, which can be validated against the U.S. Postal Service address database hosted by an external party). When the input processor 220 completes validation, each quote record may be stored in a database 240 with its validation result. In example embodiments, the database 240 corresponds to the bulk quote database 120 in FIG. 1 and can be implemented using conventional memory storage, queues, and the like.

In example embodiments, the input file validation process initiates a bulk quote input validation process whereby the input processor 220 validates the organization by organization ID through a hypertext transfer protocol (HTTP) call to the data validation service 230 through route /v1/bulk-quotes/organization stored in the bulk quote production database 160. The input processor 220 also validates bulk quotes parameters, and a bulk quotes record is created and stored in a bulk quoting queue associated with the database 240. The input processor 220 also may read a CSV file containing the file's path, partner id, and the bulk quotes global parameters line by line. For each line, the input data may be validated and the addresses for the individuals in the CSV file may be checked by, for example, calling a routine (e.g., US Postal Service database) to validate the addresses. The input processor 220 may further check to determine if a policy/lead exists. HTTP calls to the production system 150 may be avoided by instead using a read-only bulk quote production database 160. A bulk quote data microservice may push a message to prefill the bulk quote quoting queue after the quote record has been successfully created. The bulk quote, with message data including the quote id, also may be stored in a quote pending queue of the database 240.

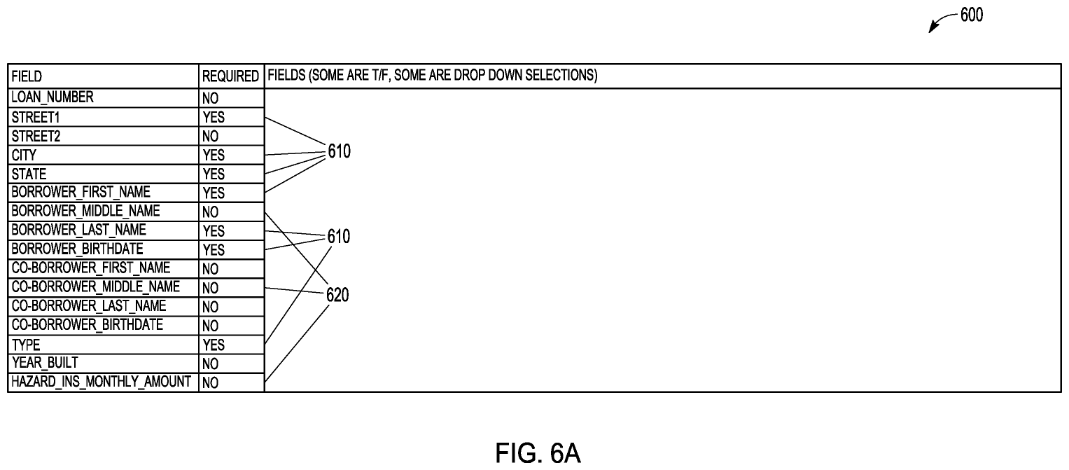

Once an individual quote record has been validated (other records for the same job can still be processing for validation), it is picked up by the quote processor 250, which is responsible for multiple steps in generating a bulk quote, all of which can be performed in parallel for different states of the quote records. In addition, as will be described below with respect to FIG. 5, the same quote records may be processed by different hardware and/or software instances of quote processors 250 in different states.

The quote processor 250 takes a validated quote record provided by the input processor 220 and retrieves external data for the quote record from data vendors 260. For example, when the quote records relate to home insurance services, the data from the data vendors 260 may include information such as square footage and fire risk. Of course, the data vendors 260 may provide different types of information for different types of services subjected to bulk quoting. Since some external data vendors 260 have rate limitations for their APIs, the number of quote processors 250 that may process this state may be programmatically limited by the bulk quote service 110 to accommodate such restrictions.

Once data has been pulled from a data vendor 260 for a quote record, the data becomes ready for a quote rating. The quote processor 250 may read the bulk quote from a quote pending queue of the database 240 and call a property/casualty insurance data analytics provider (e.g., Verisk) for quotes for rebuilding costs and the like. An existing cache of the analytics reports may be improved by adding override parameters to the cache key along with the address. The state of the quote record may be updated using a bulk quote data microservice. If some of the calls time out, the state may be updated to VALIDATED and returned to the bulk quote quoting queue. The quote processor 250 may further call a policy and rating service 270 to generate an initial rating (e.g., insurance premium rating) for the quote record using the input that was validated by the input processor 220 and the data that was retrieved from the data vendors 260. The quote processor 250 may further update the state of the quote by calling the bulk quote data microservice to get a quote from a property service and/or data vendors 260.

The policy and rating service 270 may provide one of two outcomes: either the policy and rating service 270 is able to rate the quote record, in which case the quote record would become eligible for a quote, or either the quote record is rejected for rating based on internal business rules (e.g., risk modelling). When the quote record is rejected, no further processing is performed for that quote record. However, if the quote record is eligible for quoting, the quote processor 250 retrieves a credit/insurance score associated with the customer that will be used later for a final rating (e.g., final insurance premium rating). If a credit score is not available from the policy and rating service 270, the quote record is marked as a “no hit” and the process continues.

Once credit/insurance score information is available for a quote record, the quote processor 250 takes all of the gathered information and re-runs the policy and rating service 270 with the gathered information to generate a final quote (e.g., final insurance premium quote). The quote may be stored with the quote record in the database 240 and is marked as complete.

While quotes are being generated, the output processor 280 may periodically retrieve the status for all quote records within a specific job using the job ID. If all quote records for that job are either completed or rejected, the job is complete. Once the output processor 280 identifies that a job has reached completion, it combines all the records for that job into a single output bundle, which can be a file or any other data format. The output processor 280 may read all the associated quotes from the processed bulk quote queue and combine them into an output file (e.g., S3 output file) 290 that can be shared with the partner. The single output bundle is sent as output file 290 or otherwise made available via an API to the partner's API through an API call, an S3 upload, and SFTP upload, via email, or the like.

In example embodiments, the quote processor 250 further implements a cron job that checks if all addresses have been processed. The cron job runs periodically (e.g., every minute) and calls a route on the bulk quote data microservice to count the number of quotes with the state identified as quoted or rejected. If the total count equals the total number of addresses (number of addresses on the associated bulk quotes record), a message is added to the processed bulk quote and stored in a processed bulk quote queue of the database 240.

In example embodiments, the bulk quotes model may be implemented as:

### Bulk Quotes Model

```
{
  id: UUID,
  organization_id,
  input_file_path,
  output_file_path,
  parameters: JSONB,
  number_of_address,
  state: IN_PROCESS|DONE|REJECTED_WITH_ERROR,
}
```

In the example embodiments, the quote model may be implemented as:

### Quote Model

```
{
  id: UUID,
  bulk_quotes_id,
  input_parameters: {street, street2, city, zip, state, ...overrides},
  state: NEW|VALIDATED|QUOTED|REJECTED
  // The structure of the following clumons should be aligned with the Lead
  model
  personal_info: JSONB,
  property_data: JSONB,
  adjustments: JSONB,
  optional_coverages: JSONB,
  insurance_score: JSONB,
  quote: JSONB,
}
```

In the example embodiments, the API end points (“service routes”) may be implemented as follows:

### Service Routes

// External routes. Can be accessed by authorized agents
POST /v1/start-bulk-quotes-pipeline
{filepath, partnerId, parameters}
GET /v1/bulk-quotes/id
GET /v1/quote/id
// Internal routes. Should be only accessible within the bulk quote service
landscape
POST /v1/bulk-quotes
{filepath, partnerId, numberOfAddresses, parameters}
PATCH /v1/bulk-quotes/id
{state}
POST /v1/quote
{address, personalInfo, parameters}
PATCH /v1/qoute/id
{prefill, quote}

In an example embodiment, the bulk quote service 110 illustrated in FIG. 2 may be deployed by implementing a container orchestration system, such as Kubernetes or terraforms, for automating the application deployment, scaling, and management of the application containers across clusters of hosts.

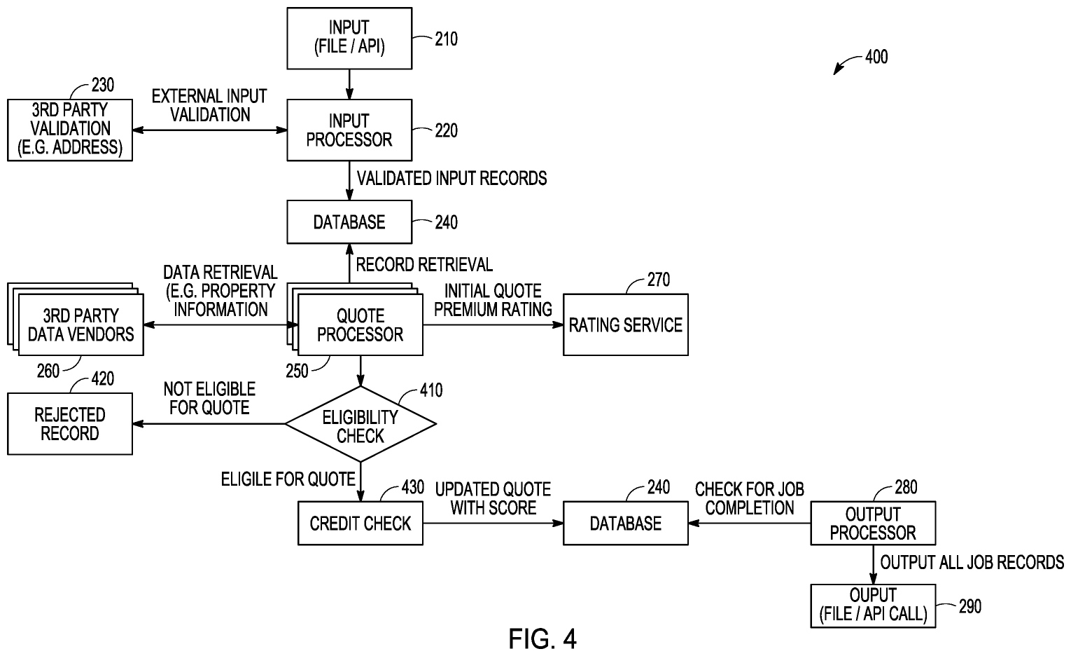

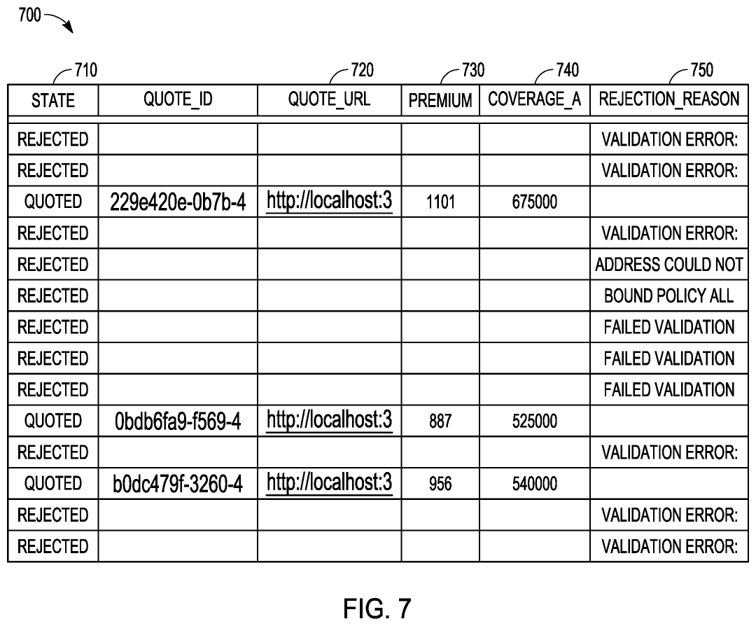

FIG. 3 illustrates a state diagram for the quote processor 250 of the bulk quote service 110 of FIG. 2 in an example embodiment. As illustrated, the quote processor 250 includes at least six states 310-360 including: input validated (310), ready for rating (320), eligible for quote (330), has credit score (340), quote complete (350), and quote rejected (360). As illustrated, in the “input validated” state 310, the quote processor 250 checks at 315 if the third party data from the data vendors 260 has been received before transitioning to the “ready for rating” state 320. If the data from the data vendors 260 is not available, the quote processor 250 transitions to the “quote rejected” state 360. Similarly, in the “ready for rating” state 320, the initial rating is obtained at 325. If the quote data passes the initial rating at 325, the quote processor 250 transitions to the “eligible for quote” state 330. However, when the quote data does not pass the initial rating at 325 (e.g., the quote data does not pass the business rules of the initial rating), then the quote processor 250 transitions to the “quote rejected” state 360. The quote process transitions from the “eligible for quote” state 330 to the “has credit score” state 340 upon receipt of the credit score and transitions from the “has credit score” state 340 to the “quote complete” state 350 upon receipt of the final rating. As will be described below with respect to FIG. 7, the quote processor 250 may include a plurality of hardware and/or software instances that are in different states at a given time whereby multiple sets of quote data may be processed in parallel.

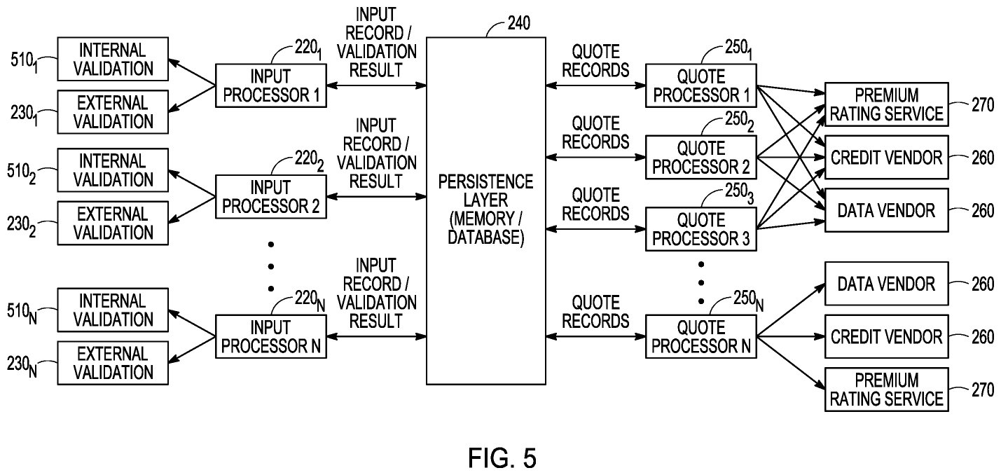

FIG. 4 illustrates a flow chart of the operation of the bulk quote service 110 of FIG. 2 in an example embodiment. As illustrated, the input file 210 is provided to input processor 220 to validate the received quote records in input file 210. The input processor 220 may perform internal validation and may also call a third party data validation service 230 to validate the input records (e.g., address) in the input file. The validated input records are provided to the database 240 for storage until retrieved by the quote processor 250. As noted above, the quote processor also may retrieve data (e.g., property information) from third party vendors 260 and provide the gathered data to a policy and rating service 270 to generate an initial quote rating. The quote processor 250 also may process the initial quote rating at 410 to determine if the credit rating is sufficient to generate a quote. If the customer is not eligible for a quote, the quote record is rejected at 420. Otherwise, a credit check is performed at 430 and the quote is updated with the customer's credit score. The updated quote is stored in database 240. Once the output processor 280 determines that the bulk quote job has been completed, the job records are pulled from the database 240 and provided as output files 290 to the partner's API or otherwise made available to the partner.

FIG. 5 illustrates parallelization of the bulk quote service 110 of FIG. 2 in an example embodiment. As noted above, the quote processor 250 may include multiple hardware and/or software instances 250₁ through 250ₙ that each process quote records and have different states to accommodate the processing of the respective quote records. This feature enables multiple quote records to be processed in parallel. To accommodate such parallel processing, the quote processing is divided into stages that permit the entire quote processing to be performed in parallel.

For example, the input processor 220 may also include multiple hardware and/or software instances 220₁ through 220ₙ that perform internal validation 510₁ through 510ₙ and external validation 230₁ through 230ₙ in parallel for respective quote records. The input records/validation results for the respective quote records are stored in parallel in the database 240. The quote records stored in the database 240 may be processed in parallel by the respective quote processor instances 250₁ through 250ₙ that may proceed at different rates through the different states illustrated in FIG. 3. As described above with respect to FIG. 2, each instance of the quote processor 250 may access external credit/data vendors 260 as well as a policy and rating service 270. It is noted that, in accordance with demand, the external credit/data vendors 260 may have multiple APIs and the policy and rating service 270 may have multiple instances and/or APIs to accommodate the demand of the quote processor instances 250₁ through 250ₙ. Thus, by breaking the quote processing into tasks that may be conducted in parallel and providing respective states for the quote processor 250, the quotes may be generated rapidly and in bulk.

### Example Embodiment

In an example embodiment, a batch file of prospects for insurance may be input for pre-quoting. In this example embodiment, an insurance provider may expose an application programming interface (API) that intakes a file from a specified repository (for a batch file use case). The batch file may include the following required and optional fields for each partner:
Name of partner;
Input specifications (in secure file transfer protocol (SFTP));
Output specifications (in SFTP);
List of internal emails (for use in future notifications); and
List of external emails (for use in future notifications).
   The insurance partner may configure the priority of partners as desired.

The insurance provider may handle any request for an insurance quote by providing an API call from an integration with a real-time process or a batch file that is uploaded by the insurance provider. The fields that are expected in either approach are the same. Some fields are required; some are optional. However, there should be a configuration for the priority of the inputs. For example, an API call may be the highest priority (a customer is close to receiving a pre-quote), and then batch partners. In example embodiments, the system may be flexible to handle batch and real-time API calls at the same time. Each submission (Batch, API) may be tracked, and the system may work to fulfill the request (Batch, API) in as short a time as possible based on the priority.

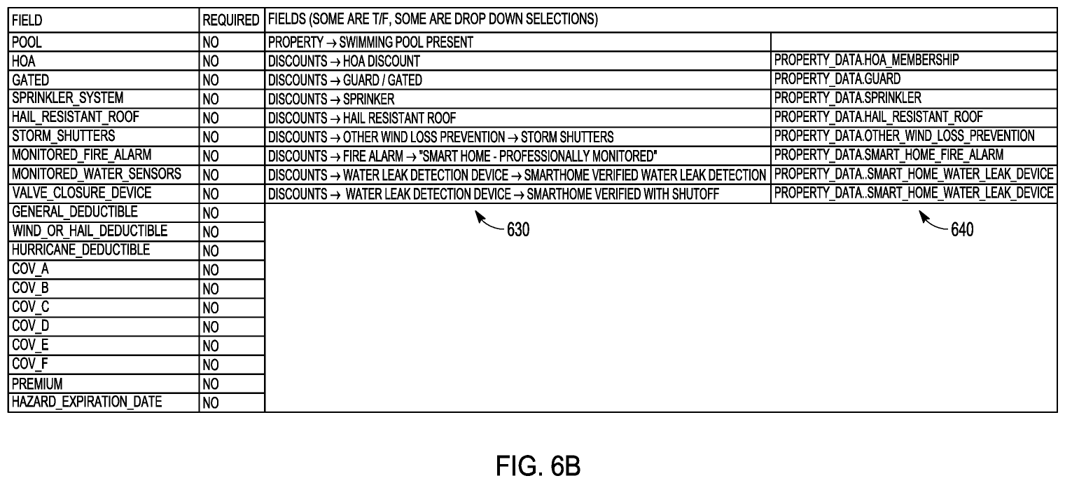

FIGS. 6A and 6B together illustrate sample input fields in a spreadsheet 600 for a bulk quote insurance system that sends quotes to a plurality of recipients in an example embodiment. As illustrated for a sample recipient, some fields 610 are required (e.g., customer address, customer name, and type of insurance), while other fields 620 are optional. The optional fields may provide additional information about the property to be insured such as the year built, characteristics of the property, and the type of coverages available in that jurisdiction. For example, COV_A may indicate coverage for primary dwelling, COV_B may indicate the amount a policy covers separate structures, COV_C may indicate the amount a policy covers personal property, COV_D may indicate the amount a policy covers medical payments, and the like. Some fields, if true, may map to and trigger certain discounts or extra charges 630 for coverages and provide links 640 to the fee/discount information. For example, if a home has a pool, an extra fee may apply. On the other hand, if the home is in a gated community and/or includes a sprinkler system, a home insurance discount may apply. This input data is validated by the input processor 220 as described above with respect to FIG. 2.

A prospect and pre-quote database may be implemented on bulk quote production database 120 (FIG. 1) to maintain current records of prospects and pre-quotes. A new batch file prospect is validated based on whether the batch file has the correct information (e.g., the required fields are completed). If the batch file does not contain valid information, an error is returned. Valid prospects are deduplicated against existing prospects. A unique prospect is defined as a unique combination of first name, last name, date of birth, and property address. If a record is new, a new prospect is created. Also, if a match is found, any additional information received is updated. A valid prospect is evaluated for eligibility using a list of eligibility rules including, for example, insurance quotes with an appropriate product/state combination and a valid insurance policy for the customer & address combination. If the record is not eligible, an error is returned including a list of the errors.

FIG. 7 illustrates sample output fields in a spreadsheet 700 for a bulk quote insurance system in an example embodiment. As illustrated, the output fields may indicate whether the inputted quote data led to a quote or was rejected in state field 710. When a quote is generated, a link 720 to the quote URL may be provided in field 720. The corresponding insurance premium and coverage amount may also be provided in fields 730 and 740, respectively. If the quote is rejected for any reason, the reason for the rejection may be provided in field 750.

A status for the prospect is maintained in the bulk quote production database 120. If the prospect is an existing customer of the insurance provider (e.g., the first name+last name+property address match), then that prospect's status is set to “customer” so that the existing customer is not inadvertently quoted. If the first name/last name and/or property address do not match, then the prospect may be quoted. If the prospect is not eligible, then the prospect's status is set to “ineligible.” Otherwise, the status is set to “active.” Once the batch file has been evaluated, each eligible record uploaded from an input file creates not only a prospect but also a pre-quote.

To generate pre-quotes, the system identifies all valid, eligible prospects from an input file and screens for high risk quotes. The entire quoting process is run without promotional scores, and if a quote is sent for referral/rejection with a predetermined promotional score, that prospect may not be quoted. The system also may look to see if an existing valid pre-quote exists for a prospect. Valid in this case means it is for the same customer (first name, last name) and property address and the expiration date is more than a set number of days (e.g., 30 days) from the current date and that there has been no rate change covering that property since the latest quote was generated. To implement the rate change feature, the system should be aware of rate changes.

The bulk quote system in example embodiments may further call to retrieve property/casualty insurance data analytics (e.g., Verisk) for quotes for rebuilding costs. The system may retry calls multiple (e.g., 3) times before sending an error message. The system may prioritize cached data before making a call for new data. If the analytics data cannot be produced, an error may be issued. Based on the analytics data, the system may evaluate further eligibility criteria. For example, a standard HO3 homeowners insurance policy may require address information provided from at least one data source including at least the year built and the square footage, Coverage A (dwelling coverage), roof information (age+material), number of family units (e.g., 1 to 4), and FireLine score (e.g., 0 to 12). If the insurance is HO3 or HO6 (co-op or condo), the requirements may further indicate whether Public Protection Classification (PPC) is acceptable and whether a FireLine score is acceptable.

If the prospect does not meet the enumerated criteria, the pre-quote process is exited and the prospect is set to “ineligible.” The rejection reason may also be stored for use in the bulk quote return message. Where available, the bulk quote system may also call to retrieve an instant consumer credit prescreen score. If a consumer credit prescreen score is pulled, a firm offer of insurance may be required by law, so the system may be programmed to never quote an “ineligible” prospect. Also, a pre-quote may only be produced using valid partner data, and an “ineligible” prospect may not be pre-quoted. Errors in retrieving partner data may return an error explaining the issue. Similarly, errors in creating an insurance quote may return an error explaining the issue. On the other hand, if the pre-quote is successful, the pre-quote fields specifications and expiration date (e.g., set for 90 days from the date the pre-quote is successfully returned) may be returned. If the pre-quote is unsuccessful, a generic error message may be returned for the pre-quote. For example, the system may elect to fail an individual pre-quote if it has not produced a result within a certain period of time (e.g., 90 seconds). Failed runs may be provided to a retry queue. It will be appreciated that failure of one quote does not impact the success of other quotes and that the reasons for the failure may be tracked and monitored.

In example embodiments, partner calls may be reduced by requesting and caching pre-quote data. For example, for consumer credit data, a data cache may be created that includes a full set of data returned, a valid flag, and a valid expiration date for each customer in the batch file. An expiration date (e.g., 60 days) may be set from the day the consumer credit data was returned. Similarly, a data cache may be created for the analytics data that includes a full set of data returned, a valid flag, and a valid expiration date (e.g., 120 days) for each record from the date the analytics data was returned. Old data may be invalidated on a daily basis and the data re-run. For consumer credit data, when the data is invalid, the system may check to see if the consumer credit data is linked to a valid quote in the database. If yes, a request for new consumer credit data is sent. If no, a request for new consumer credit data is not sent. Similarly, for analytics data, when the data is invalid, the system checks to see if the analytics data is linked to a valid prospect in the database. If yes, a request for analytics data is sent; otherwise, no request for analytics data is sent.

When the pre-quote generator is run for a de-duplicated prospect, the pre-quote generator checks for valid, cached consumer credit data before sending a request to the partner API. If there is valid, cached consumer credit data, the cached data is used; otherwise, the partner is called for data via the API. On the other hand, if there is consumer credit data but it is too old (e.g., over 60 days old), the partner is called for data. When the pre-quote generator is run for a de-duplicated prospect, the pre-quote generator also checks for valid, cached analytics data before sending a request to the partner API. If there is valid, cached analytics data, the cached analytics data is used; however, if there is no valid data, the partner is called for data. Also, if there is data but it is too old (e.g., over 120 days old), the partner is called for data.

It will be appreciated by those skilled in the art that there are many opportunities for errors when processing batch quotes. The system thus tracks and enables user to view process errors by providing detailed error logs. In example embodiments, for each API call or batch request that does not succeed, an error is returned as an output including, for example, an error with the prospect data passed via input, an error that the product is not covered by the insurance provider, an error that the insurance provider was unable to process the quote, etc. For each API call or batch request, the error may be logged in greater detail for internal use by further specifying, for example, that the quote could not be processed due to a data vendor, documenting the vendor and nature of the issue, or due to an issue with the insurance provider. All errors may be saved in an easy-to-access and read file for later processing.

The bulk quote system may also be adapted to monitor lead outputs (API+Batch File) through ongoing monitoring of batch file runs. In this case, the bulk quote system sends an API response for an API call and provides a document covering the output fields. The system also generates a .csv output file for the batch file input and provides a document covering the output file fields. For example, the bulk quote system may place the .csv output file in an SFTP endpoint and send a notification email to a user. A log also may be kept that can be queried through an API to show batch file progress for any or all batch processes. The resulting output may include the batch process ID, the partner ID, the total number of records, the number of errors, the number of successes, the number of entries remaining to be processed, and the like.

Upon receipt of the pre-quote, the customer may interact with the pre-quote by, for example, clicking on a URL that has not expired. The customer is then placed immediately in the web lead flow at their preliminary pre-quote.

In example embodiments, the system may handle multiple bulk files in parallel and understand the priority of the bulk files (e.g., first in, first out). The system also may have a 99.9% availability rate and execute all calls asynchronously. In example embodiments where rate changes are tracked, the system may also re-quote pre-quotes based on rate changes. In this case, when there is a rate change, all valid cached pre-quotes that are impacted by the rate change are identified and requoted.

The disclosed systems and methods thus provide the practical application of breaking quote processing into tasks that may be conducted in parallel (and hence are more scalable) and providing respective states for a quote processor whereby quotes may be generated rapidly and in bulk. In the context of insurance quotes, the bulk quote system described herein further facilitates the comparison of insurance premiums for presentation to customers. Also, many bulk quotes may be run per day, greatly improving the efficiencies of the quoting process. One transaction may return all information needed for a quote. Also, the quoting process may be run and the criteria checked at a later time and the quoting process rerun. This mitigates the rate limiting impact of data vendors. The bulk quoting system further recognizes that quotes may have been sent previously to minimize duplication of quotes. Also, since the bulk quoting system is separate from the production system, quoting may be performed in a single step once the server validates the data and pulls the validated input data. These and other practical advantages will be apparent to those skilled in the art.

### Modules, Components, and Logic

Certain embodiments are described herein as being implemented on platforms such as AWS that include software or logic or a number of components, modules, or mechanisms. Modules may constitute either software modules (e.g., code embodied on a machine-readable storage device) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a FPGA or an ASIC. A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” or “hardware processor” as used herein should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS) where the services are provided by transaction, by processor cycles used, by time, by bandwidth consumed, and the like. At least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-7 are implemented in some embodiments in the context of a machine and an associated software architecture. The sections below describe a representative architecture that is suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things” while yet another combination produces a server computer for use within a cloud computing architecture. Not all combinations of such software and hardware architectures are presented here as those of skill in the art can readily understand how to implement the inventive subject matter in different contexts from the disclosure contained herein.

In example embodiments, Amazon's S3 system provides an object storage architecture that can be employed to store objects through a web service interface and that allows for uses such as storage for Internet applications, backup and recovery, data lakes for analytics, and cloud storage. The basic storage units of the S3 system are objects that are organized into buckets, where each object is identified by a unique, user-assigned key. The S3 system further provides a console, an AWS SDK, and a representational state transfer (REST) application programming interface (API) for managing the buckets and the objects. Requests for data in the buckets are authorized using an access control list associated with each object bucket. The objects are addressable using HTTP uniform resource locators (URLs). AWS gives the user control over user identity, permissions, and keys and uses identity and access management (IAM) policies to control the level of access granted to each user. If implemented using S3 buckets, the S3 features such as server-side encryption, versioning, and the like may be implemented as well. In example embodiments, SFTP services may be implemented as AWS Lambda functions that enable the user to build an intelligent file transfer protocol (FTP) site that processes incoming files as soon as they are uploaded, queries the files as appropriate, and connects the files to a data ingestion process. Also, in example embodiments, all records may be loaded into the Amazon SQS service whereby a worker server may pick up an address and provide a quote using the information associated with that address. The quote may be written into a file and the file written to an S3 bucket for further processing.

### Example Machine Architecture and Machine-Readable Storage Device

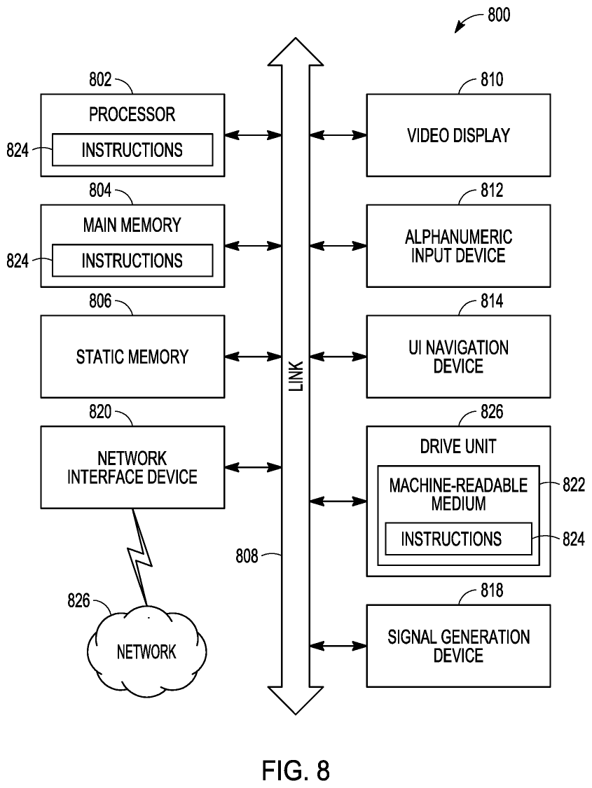

FIG. 8 is a block diagram illustrating components of a machine 800, according to some example embodiments, able to read instructions from a machine-readable storage device and to perform any one or more of the methodologies discussed herein. In this example, machine 800 may implement the bulk quoting service 100 of FIG. 1 in example embodiments. The machine 800 may include more than one processor 802 to execute or implement one or more of the application(s)/platform(s) described herein. The one or more processors 802 may be any type of commercially available processor, such as processors available from the Intel Corporation, Advanced Micro Devices, Texas Instruments, or other such processors. Further still, the one or more processors 802 may include one or more special-purpose processors, such as a Field-Programmable Gate Array (FPGA) or an Application Specific Integrated Circuit (ASIC). The one or more processors 802 may also include programmable logic or circuitry that is temporarily configured by software to perform certain operations. Thus, once configured by such software, the one or more processors become specific machines (or specific components of a machine) uniquely tailored to perform the configured functions and are no longer general-purpose processors.

The bulk quote service 100 of FIG. 1 described herein may further include various storage device(s) and/or machine-readable storage devices for storing the application(s)/platform(s) and/or the documents and other data from the user and/or respective third-parties. The machine-readable storage device includes one or more devices configured to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable storage device” should be taken to include a single storage device or multiple media (e.g., a centralized or distributed database, or associated caches and servers) able to store the application(s)/platform(s) and/or the documents and other data from the user and/or the respective third-parties. Accordingly, the machine-readable storage device may be implemented as a single storage apparatus or device, or, alternatively and/or additionally, as “cloud-based” storage systems or storage networks such as the S3 system that include multiple storage apparatus or devices.

In one embodiment, the application(s)/platform(s) are written in a computer-programming and/or scripting language. Examples of such languages include, but are not limited to, C, C++, C#, Java, JavaScript, Perl, Python, or any other computer programming and/or scripting language now known or later developed.

Specifically, FIG. 8 shows a diagrammatic representation of the machine 800 in the example form of a computer system, within which instructions 824 (e.g., software, a program, an application, an applet, an app, or other executable code) for causing the machine 800 to execute any one or more of the methodologies discussed herein. For example, the instructions 824 may cause the machine 800 to execute the state diagram of FIG. 3 and the flow diagram of FIG. 4. Additionally, or alternatively, the instructions 824 may implement one or more of the components of FIG. 1, FIG. 2, and FIG. 5. The instructions 824 transform the general, non-programmed machine 800 into a special purpose machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a PDA, or any machine capable of executing the instructions 824, sequentially or otherwise, that specify actions to be taken by machine 800. Further, while only a single machine 800 is illustrated, the term “machine” shall also be taken to include a collection of machines 800 that individually or jointly execute the instructions 824 to perform any one or more of the methodologies discussed herein.

The machine 800 may include processors 802, main memory/storage 804, 806, and I/O components 820, which may be configured to communicate with each other such via a bus 808. In an example embodiment, the processors 802 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may execute the instructions 824. The term “processor” is intended to include multi-core processor that may comprise two or more independent processors (sometimes referred to as “cores”) that may execute instructions 824 contemporaneously. The machine 800 also may include a single processor with a single core, a single processor with multiple cores (e.g., a multi-core process), multiple processors with a single core, multiple processors with multiples cores, or any combination thereof.

The memory/storage 804, 806 may include a memory such as a main memory 804, or other memory storage, and a static memory 806, both accessible to the processors 802 via the bus 808. The main memory 804 stores the instructions 824 embodying any one or more of the methodologies or functions described herein. The instructions 824 may also reside, completely or partially, within the memory 806, within the drive unit 816, within at least one of the processors 802 (e.g., within the processor's cache memory), or any suitable combination thereof, during execution thereof by the machine 800. Accordingly, the memory 806, the drive unit 816, and the memory of processors 802 are examples of machine-readable media.

As used herein, “machine-readable storage device” means a device able to store instructions 824 and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable storage device” should be taken to include a single storage device or multiple media (e.g., a centralized or distributed database, or associated caches and servers) able to store instructions 824. The term “machine-readable storage device” shall also be taken to include any medium, or combination of multiple media, that is capable of storing instructions (e.g., instructions 824) for execution by a machine (e.g., machine 800), such that the instructions, when executed by one or more processors of the machine 800 (e.g., processors 802), cause the machine 800 to perform any one or more of the methodologies described herein. Accordingly, a “machine-readable storage device” refers to a single storage apparatus or device 822, as well as “cloud-based” storage systems or storage networks that include multiple storage apparatus or devices. The term “machine-readable storage device” excludes signals per se.

The input/output (I/O) components 810, 812 may include a wide variety of components to receive input, provide output, produce output, transmit information, exchange information, capture measurements, and so on. The specific I/O components 810, 812 that are included in a particular machine will depend on the type of machine. For example, portable machines such as mobile phones will likely include a touch input device or other such input mechanisms, while a headless server machine will likely not include such a touch input device. It will be appreciated that the I/O components 810, 812 may include many other components that are not shown in FIG. 8. The I/O components 810, 812 are grouped according to functionality merely for simplifying the discussion herein and the grouping is in no way limiting. In various example embodiments, the I/O components 810, 812 may include output components 810 and input components 812. The output components 810 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 812 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 810, 812 may include biometric components, motion components, environmental components, or position components among a wide array of other components. For example, the biometric components may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components may include acceleration sensor components (e.g., accelerometer), gravitation sensor components, rotation sensor components (e.g., gyroscope), and so forth. The environmental components may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 818, 820 may include communication components operable to couple the machine 800 to a network 826 or external devices via appropriate coupling (not shown). For example, the communication components 818, 820 may include a network interface component 820 or other suitable device such a signal generator 818 to interface with the network 826. In further examples, communication components 818, 820 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The external devices may be another machine or any of a wide variety of peripheral devices (e.g., a peripheral device coupled via a USB).

Moreover, the communication components 818, 820 may detect identifiers or include components operable to detect identifiers. For example, the communication components 818, 820 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF, Ultra Code, UCC RSS-2D bar code, and other optical codes), or acoustic detection components (e.g., microphones to identify tagged audio signals). In addition, a variety of information may be derived via the communication components 818, 820, such as location via Internet Protocol (IP) geo-location, location via Wi-Fi® signal triangulation, location via detecting a NFC beacon signal that may indicate a particular location, and so forth. UI navigation devices 814 may also be provided as appropriate for the particular application.

### Transmission Medium

In various example embodiments, one or more portions of the network 826 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 826 or a portion of the network 826 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 824 may be transmitted or received over the network 826 using a transmission medium via a network interface device (e.g., a network interface component included in the communication components 818, 820) and utilizing any one of a number of well-known transfer protocols (e.g., hypertext transfer protocol (HTTP)). Similarly, the instructions 824 may be transmitted or received using a transmission medium via the coupling (e.g., a peer-to-peer coupling) to external devices. The term “transmission medium” shall be taken to include any intangible medium that is capable of storing, encoding, or carrying instructions 824 for execution by the machine 800, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated or by the particular elements identified. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The systems and methods described herein are captured within the scope of the following claims. It is understood by those skilled in the art that the claims encompass specific embodiments as well as embodiments that are not specifically described herein but which may include equivalent components and steps to those described herein as well as other features and modifications that would be apparent to those skilled in the art.

We claim:

1. A bulk quote service system comprising:
a machine-readable storage device that stores computer-executable instructions; and
at least one processor communicatively coupled to the machine-readable storage device and including multiple instances having different states representing different quote record processing stages for processing respective quote records as parallel quote processing tasks, the at least one processor executing the computer-executable instructions to configure the system to generate bulk quotes by:
receiving a bulk quote file;
splitting the bulk quote file into individually processable quote records; and
each instance of the at least one processor validating a quote record, retrieving data for a validated quote record from at least one external data vendor, generating a rating for the validated quote record using data in the validated quote record and data retrieved from the at least one external data vendor, generating a final quote for the validated quote record using the data in the validated quote record, data from the at least one external data vendor, and the rating for the validated quote record, and associating the final quote with the validated quote record.

2. A system as in claim 1, wherein the at least one processor further executes instructions to output a plurality of final quotes associated with prospects.

3. A system as in claim 1, wherein the different states of the processor instances include input validated, ready for rating, eligible for quote, has credit score, quote complete, and quote rejected.

4. A system as in claim 1, wherein the bulk quote file includes a comma separated values file including message data including a file path, a partner ID, and bulk quotes global parameters.

5. A system as in claim 4, wherein each instance of the at least one processor validates the quote record by performing format validation for data in the quote record and accessing a third party validation service to validate information for a prospect in the bulk quote file.

6. A system as in claim 1, further comprising a database that stores the final quote with the validated quote record for each quote record processed by each instance of the at least one processor.

7. A system as in claim 1, wherein each instance of the at least one processor generates a rating for the validated quote record by retrieving a at least one of a credit score or an insurance score associated with a prospect and uses the at least one credit score or insurance score associated with the prospect to generate the final quote.

8. A system as in claim 7, wherein each instance of the at least one processor generates the final quote for the validated quote record by regenerating the rating with the at least one credit score or insurance score, the data in the validated quote record, and the data retrieved from the at least one external data vendor.

9. A system as in claim 1, wherein the at least one processor assigns a job ID to each quote record and, while a final quote is being generated, the at least one processor retrieves data using the job ID.

10. A system as in claim 9, wherein when all quote records for the job ID are either completed or rejected, all quote records for the job ID are combined into a single output bundle for output.

11. A system as in claim 1, wherein the at least one processor checks to determine whether a valid quote exists for a prospect and marks a quote record for the prospect as invalid when the valid quote exists.

12. A system as in claim 1, wherein the at least one processor generates an error log when processing of a quote record fails, the error log including a reason for failure of the processing of the quote record.

13. A system as in claim 12, wherein the error log indicates that the quote record could not be processed due to an issue with a provider or a data vendor and, when the quote record could not be processed due to an issue with a data vendor, documents the data vendor and the nature of the issue with the data vendor.

14. A system as in claim 1, wherein the at least one processor maintains a log that shows a state of processing of each quote record, the log including a job ID, a partner ID, a total number of quote records, a number of errors, a number of successes, and a number of quote records remaining to be processed.

15. A method of providing bulk quotes, the method comprising:
receiving a bulk quote file;
splitting the bulk quote file into individually processable quote records; and
processing, using multiple processor instances having different states representing different quote record processing stages, respective quote records as parallel quote processing tasks, the processing by each processor instance including:
validating a quote record,
retrieving data for a validated quote record from at least one external data vendor,
generating a rating for the validated quote record using data in the validated quote record and data retrieved from the at least one external data vendor,
generating a final quote for the validated quote record using the data in the validated quote record, data from the at least one external data vendor, and the rating for the validated quote record, and
associating the final quote with the validated quote record.

16. A method as in claim 15, further comprising outputting a plurality of final quotes associated with prospects.

17. A method as in claim 15, wherein each processor instance generates the final quote for the validated quote record by regenerating the rating with at least one of a credit score or an insurance score, the data in the validated quote record, and the data retrieved from the at least one external data vendor.

18. A method as in claim 15, further comprising assigning a job ID to each quote record, retrieving data using the job ID while a final quote is being generated, and when all quote records for the job ID are either completed or rejected, combining all quote records for the job ID into a single output bundle for output.

19. A method as in claim 15, further comprising processing the rating to determine if a credit rating for the validated quote record is sufficient to generate a quote and, when the validated quote record is sufficient to generate a quote, performing a credit check and updating the validated quote record with a credit score for a prospect associated with the validated quote record.

20. A machine-readable storage device that stores computer-executable instructions that, when executed by at least one processor, implements a method of providing bulk quotes, the method comprising:
receiving a bulk quote file;
splitting the bulk quote file into individually processable quote records; and
processing, using multiple processor instances having different states representing different quote record processing stages, respective quote records as parallel quote processing tasks, the processing by each processor instance including:
validating a quote record,
retrieving data for a validated quote record from at least one external data vendor,
generating a rating for the validated quote record using data in the validated quote record and data retrieved from the at least one external data vendor,
generating a final quote for the validated quote record using the data in the validated quote record, data from the at least one external data vendor, and the rating for the validated quote record, and
associating the final quote with the validated quote record.
